(19) United States
(12) Patent Application Publication
(10) Pub. No.: US 2003/0154369 A1
(43) Pub. Date: Aug. 14, 2003

(54) Single chip microcomputer

(76) Inventors: Yoshinori Teshima, Toyota-shi (JP); Shuji Agatsuma, Toyohashi-shi (JP)

Correspondence Address: POSZ & BETHARDS, PLC, 11250 ROGER BACON DRIVE, SUITE 10, RESTON, VA, 20190, US

(21) Appl. No.: 10/329,777

(22) Filed: Dec. 27, 2002

(30) Foreign Application Priority Data
Dec. 27, 2001 (JP) 2001-397544

(51) Int. Cl. G06F 15/177

(52) U.S. Cl. 713/1

(57) ABSTRACT

Disclosed is a single-chip microcomputer capable of facilitating debugging even in the case of including a plurality of CPUs. In the single-chip microcomputer 41 carrying two CPUs 41A and 41B, the CPU 42A is released from its reset condition by a power-on reset circuit 33 at power-on, while another CPU 42B is released from its reset condition through a CPU(B) reset register 44 in accordance with processing based on the control program of the CPU 42.

### BACKGROUND OF THE INVENTION

1. Industrial Field of the Invention

The present invention relates to a single-chip microcomputer designed such that each of a plurality of CPUs reads a control program corresponding to each of numbers from a common program memory for conducting each processing.

2. Description of the Related Art

In general, CPU to be mounted in a single-chip microcomputer (which will be referred to hereinafter as a “microcomputer”) is one in number. However, in a case in which many peripheral circuits reside around a microcomputer, if one CPU conducts processing pertaining to them, it takes much time for the processing, which leads to the impairment of the efficiency. For this reason, it is considered that a multiple-CPU configuration in which a plurality of CPUs is mounted on a microcomputer is put to use so that the plurality of CPUs distributively conduct the processing pertaining to the peripheral circuits, thus enhancing the processing efficiency in total.

FIG. 3 is a functional block diagram showing one example of a microcomputer considering such a multiple-CPU configuration. A microcomputer 1 includes two CPUs 2A and 2B, and is equipped with, as a first peripheral circuit group 3 around a core, an FPU (Floating Point Unit) 4, a RAM 5, interruption controllers 6A and 6B, a ROM (program memory) 7, a DMA (Direct Memory Access) controller 8, a DPLL (Digital Phase Locked Loop) circuit 9, an ICE (In Circuit Emulator) 10 and other circuits. In addition, in a state connected through a bus controller 12 thereto, as a second peripheral circuit group 11, there are provided a timer 13, an A/D converter 14, a PWM signal circuit 15, an I/O port 16, a boot ROM 17, a serial communication circuit 18 and other circuits.

Furthermore, in the microcomputer 1, the Harvard architecture is employed for the improvement of the processing efficiency of the two CPUs 2A and 2B, and around the core, the buses for the CPUs 2A and 2B are placed in a divided condition. Moreover, divided are the buses for the FPU 4 and the RAM 5 to which both the CPUs 2A and 2B gain access at a high frequency and the buses for the first peripheral circuit group 3.

In the following description, if the distinction between the CPUs 2A and 2B is not particularly necessary, the reference characters A and B will be omitted. That is, the CPU 2 and the ROM 7 are connected to each other through address buses 19 and data buses 20, while the FPU 4 and the RAM 5 are connected to each other through address buses 21 and the data buses 22. In addition, the first peripheral circuit group 3 forming the other circuits around the core, including the bus controller 12, is connected thereto through address buses 23 and data buses 24. Incidentally, the connection between the ICE 10 for debugging and an external personal computer or the like is made through ports for external buses, not shown.

Moreover, the bus controller 12 and the second peripheral circuit group 11 are connected to each other through an address bus 25 and a data bus 26. The bus controller 12 internally contains an arbiter function, and in a case in which the CPUs 2A and 2B gain access through the buses 23A, 24A and the buses 23B, 24B, respectively, to the second peripheral circuit group 11, the use of the buses 25 and 26 is mediated therebetween.

The employment of such a bus arrangement enables the CPUs 2A and 2B to conduct processing concurrently without the occurrence of competition in the case of having access to bus blocks different from each other. That is, the instruction access to one ROM 7 and the data access to the other RAM 5, or the data access to one RAM 5 and the access to the other first peripheral circuit group 3, can be conducted concurrently.

Accordingly, on the CPU 2 side, a bus switching circuit 27 is located to selectively drive one of the address buses 19, 21 and 23 according to an address outputted (naturally, the switching is made with respect to the data buses 20, 22 and 24).

In addition, on the peripheral circuit side, bus controllers (arbiters) 28 to 32 are placed to accomplish the mediation in a case in which the accesses from the CPUs 2A and 2B fall into competition in the same bus block. The bus controller 28 is made to accomplish the mediation between the accesses from/to the FPU 4 and the RAM 5.

The ROM 7 stores control programs for the CPUs 2A and 2B. The CPUs 2A and 2B are simultaneously released from their reset condition by a power-on reset circuit 33 in response to the power-on of the microcomputer 1 so that the access starts at the address “0” of the ROM 7.

FIG. 4 is a flow chart schematically showing a flow of processing after the reset release of the CPUs 2A and 2B. First, each of the CPUs 2A and 2B implements an instruction to read out a register (not shown) (for example, a CPU number register) for seeing a number allocated thereto (in this case, the distinction therebetween is made using (A) and (B) for the purpose of avoiding the confusion with the reference characters), and makes “CPU decision” (step S1).

Although this CPU number has the identical address on a program, for example, a hardware arrangement is made such that, in a case in which the CPU 2A reads it out through the decoding including each bus request signal and others, the data 0 is read out with respect to a data bit 0, and if the CPU 2B reads it out, the data 1 is read out with respect to the data bit 0.

When the CPUs 2A and 2B see their own CPU numbers in this way, the control program addresses to be read out from the ROM 7 on the basis of the difference therebetween become different from each other so that the CPUs 2A and 2B read different programs for conducting processing, respectively.

That is, when the CPU 2A recognizes its own identity in the step S1, the CPU 2A performs the system setting (step S2). In this case, for example, the “system setting” signifies which of the CPUs processes each of a plurality of interruption factors (which of controllers 6A and 6B receives an interruption signal), the setting of system clock frequency in the DPLL circuit 9, the initialization of the RAM 5, and others.

In this connection, among the interruption factors, for example, there are a timer interruption from the timer 13, a data readout request from the A/D converter 14, a reception interruption from the serial communication circuit 18, and others.

After performing the system setting in the step S2, the CPU 2A writes data “1” in a flag storage area of the RAM 5 to set a system setting completion flag (step S3). Then, it starts the implementation of an application program (A) produced by a user (step S4).

On the other hand, if the CPU 2B recognizes its own identity in the step S2, the CPU 2B waits in the step S4 until the system setting on the CPU 2A side reaches completion. That is, the CPU 2B polls the flag storage area of the RAM 5 in step S5 and, when confirming that the system setting completion flag is set by the CPU 2A (“YES”), starts the execution of an application program (B) produced by a user (step S6). Incidentally, the CPU 2B is made to implement the setting in the interruption controller 6B side.

Meanwhile, the above-mentioned flow chart shows a case in which each of the circuits of the microcomputer 1 operates to serve expected purposes. However, at stages before the actual realization of such operations, there is a need to conduct the debugging on the hardware of the microcomputer 1 or the control program of each of the CPUs 2A and 2B.

Although this microcomputer 1 is designed such that the CPU 2A side performs the system setting in a batch fashion, in a state where a bug exists in hardware or software, it is considered that a bug also occurs, for example, in a case in which the CPUs 2A and 2B perform the system setting simultaneously. Thus, in a state where the CPUs 2A and 2B operate simultaneously to cause the bus access competition, difficulty is experienced in seeking which of the CPUs 2A and 2B involves a problem, which results in requiring extremely much time for the debugging process.

### SUMMARY OF THE INVENTION

The present invention has been developed in consideration of the above-mentioned situation, and it is therefore an object of the invention to provide a single-chip microcomputer capable of facilitating debug even in the case of including a plurality of CPUs.

In a single-chip microcomputer according to the present invention, each of a plurality of CPUs sees a number allocated thereto when being released from its reset condition and reads out a control program corresponding to the number from a program memory for conducting processing. One of the plurality of CPUs is released from its reset condition by a power-on reset circuit at the time of the power-on, while the other CPUs are released from a reset condition through processing based upon the control program for the CPU released from the reset condition by the power-on reset circuit.

For example, the necessary initial setting of the system is previously conducted by one CPU released from the reset condition by the power-on reset circuit and the other CPUs are released from the reset condition at the time of the completion of the setting, which enables the debug operation to be separately conducted before and after the system setting.

In addition, since only the one CPU performs the bus access up to the system setting stage, it is possible to facilitate the confirmation of the operation of the hardware and the debugging on the control program to be executed by the CPU. Still additionally, also with respect to the operations of the other CPUs to be released from the reset condition after the system setting, the debugging can be made after the bug occurring up to the system setting stage is fixed. This can considerably shorten the time needed for the debugging process and can improve the development efficiency.

### BRIEF DESCRIPTION OF THE DRAWINGS

FIG. 1 shows an embodiment of the present invention and is a functional block diagram illustrating an electrical arrangement of a single-chip microcomputer carrying two CPUs.

FIG. 2 is a flow chart schematically showing a flow of processing to be conducted after the two CPUs are release from a reset condition.

FIG. 3 is an illustration of a related technique, corresponding to FIG. 1 showing the present invention.

FIG. 4 is an illustration of a related technique, corresponding to FIG. 2 showing the present invention.

### DESCRIPTION OF THE PREFERRED EMBODIMENTS

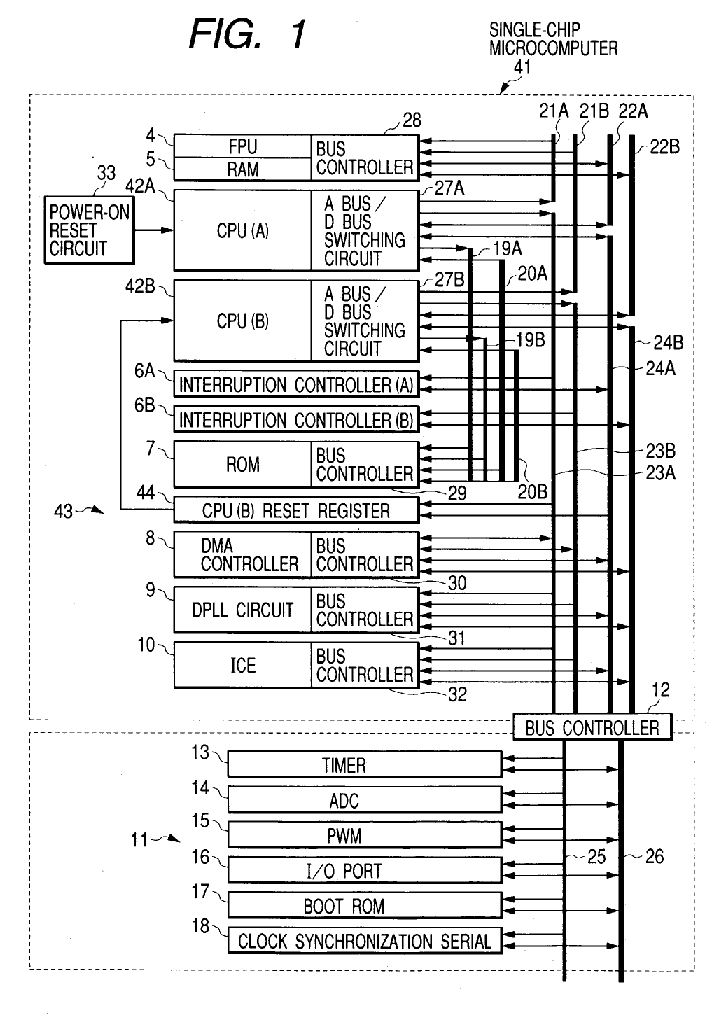

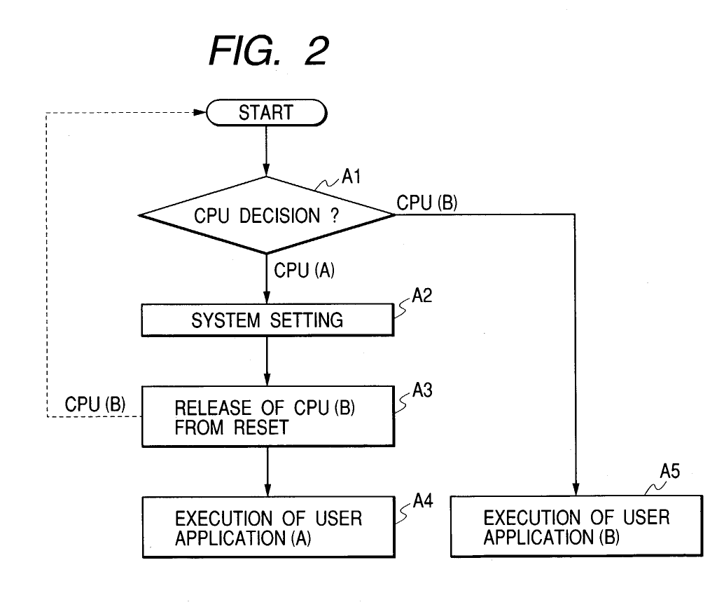

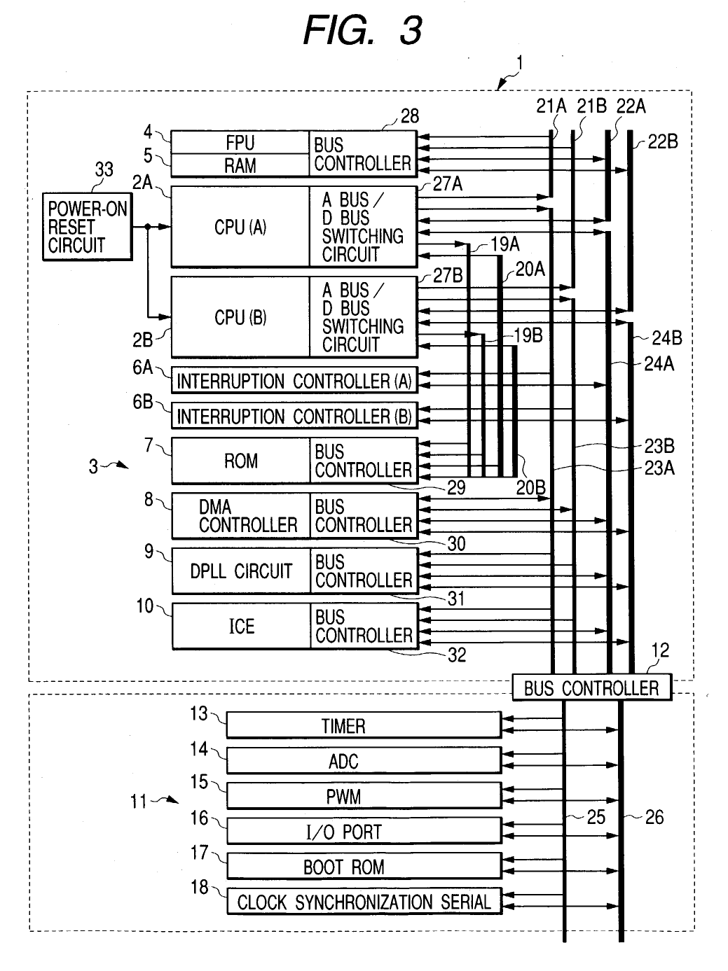

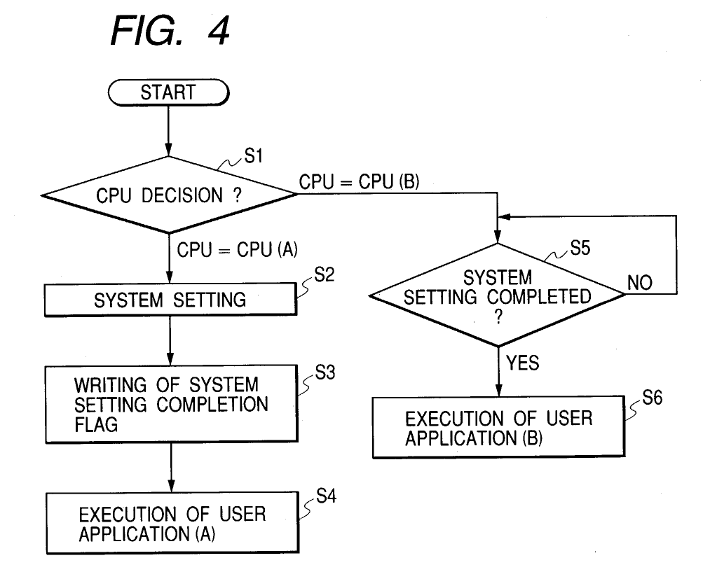

An embodiment of the present invention will be described hereinbelow with reference to FIGS. 1 and 2. In the illustrations, the same parts as those shown in FIGS. 3 and 4 are marked with the same reference numerals and the description thereof will be omitted, and a description will be given of only parts different therefrom. In FIG. 1 showing an electrical arrangement of a single-chip microcomputer 41, CPUs 42A and 42B are placed in place of the CPUs 2A and 2B, and a reset signal outputted from a power-on reset circuit 33 is given to only a reset terminal of the CPU 42A. A CPU(B) reset register 44 is additionally put in a first peripheral circuit group 43 around a core. The reset register 44 is connected to an address bus 23A and a data bus 24A, and only the CPU 42A is designed to conduct a writing operation. The reset register 44 is made up of a flip-flop and others, with an output terminal thereof being connected to a reset terminal of the CPU 42B.

In the initial state at the time of the microcomputer 41 being powered, the reset register 44 maintains the CPU 42B in a reset condition. Moreover, when CPU 42A writes arbitrary data in an address allocated to the reset register 44, the reset register 44 releases the CPU 42B from the reset condition. The other arrangement is similar to that shown in FIG. 3. However, the CPU 42B substantially has the same arrangement as that of the conventional CPU 2B.

Secondly, referring further to FIG. 2, a description will be given of an operation of this embodiment. FIG. 2 is a flow chart schematically showing a flow of processing after the release of the CPUs 42A and 42B from the reset condition. First, when being released from the reset condition by the power-on reset circuit 33, the CPU 42A makes “CPU decision” as well as the step S1 (step A1). Then, if the CPU 42A recognizes its own identity, the CPU 42A conducts the system setting for the microcomputer 41 as well as the step S2 (step A2).

Following this, the CPU 42A gains write access to the reset register 44 to release the CPU 42B from the reset condition (step A3). Subsequently, as well as the step S4, the CPU 42A starts the implementation of an application program (A) produced by a user (step A4).

On the other hand, when being released from the reset condition by the CPU 42A in the step A3, the CPU 42B starts the implementation of the flow chart of FIG. 2 at that time. Moreover, if the CPU 42B recognizes its own identity in the step A1, the CPU 42B starts to execute an application program (B) produced by a user as well as the step S5 (step A5).

As described above, according to this embodiment, in the microcomputer 41 in which the two CPUs 41A and 41B are mounted, the CPU 42A is released from its reset condition by the power-on reset circuit 33 at the time of the power-on, and another CPU 42B is released from its reset condition through the reset register 44 in accordance with the processing based on the control program for the CPU 42.

That is, up to the stage of the step A3, the CPU 42A singly gains the bus access, which results in separately conducting the debugging operation before and after the system setting, thus facilitating the confirmation as to whether or not the system setting is correctly conducted in the system A2. For example, it is possible that the ICE 10 is activated to break the implementation of the program immediately before the step A3 for confirming the setting condition.

In addition, it is possible to facilitate the confirmation of the operations of the hardware up to that stage or the debugging of the control program to be executed by the CPU 42A. Still additionally, also for the operations of the CPU 42B to be released from its reset condition after the system setting, the debugging can readily be done after the bugs up to the system setting stage is fixed. Accordingly, it is possible to considerably shorten the time needed for the debugging process and further to improve the development efficiency.

The present invention is not limited to only the embodiment described above and shown in the drawings, but the following modification and expansion are also acceptable.

The employment of three or more CPUs are also acceptable.

As the peripheral circuits, necessary circuits can properly be selected according to individual setting.

What is claimed is:

1. A single-chip microcomputer comprising a plurality of CPUs and a program memory storing control programs for said plurality of CPUs, each of said plurality of CPUs recognizing a number allocated thereto when being released from its reset condition and reading out said control program corresponding to said number from said program memory for conducting processing,
characterized in that one of said plurality of CPUs is released from its reset condition by a power-on reset circuit at power-on, and
the other CPUs are released from their reset condition through processing based on said control program for said CPU released from its reset condition by said power-on reset circuit.
